(19) United States
(12) Patent Application Publication
(10) Pub. No.: US 2023/0240163 A1
(43) Pub. Date: Aug. 3, 2023

(54) AERATING-ROLLER ATTACHMENT FOR RIDING LAWN MOWER

(71) Applicant: NATHAN WEBER, W. Columbia, SC (US)

(72) Inventor: NATHAN WEBER, W. Columbia, SC (US)

(21) Appl. No.: 17/121,883

(22) Filed: Dec. 15, 2020

(51) Int. Cl. A01B 45/02; A01D 43/12

(52) U.S. Cl. CPC A01B 45/02; A01D 43/12; A01D 2101/00

(57) ABSTRACT

The aerating-roller attachment for riding lawn mower comprises a roller, a plurality of spikes, and a mounting bracket. The aerating-roller attachment for riding lawn mower may be coupled to a riding lawn mower via the mounting bracket and may aerate a lawn. The riding lawn mower may pull the roller behind the riding lawn mower and the roller may rotate as the riding lawn mower moves. The plurality of spikes may be pressed into the lawn and then withdrawn from the lawn as the roller turns. The weight of the riding lawn mower may force the plurality of spikes into the lawn leaving a plurality of aeration holes such that water, nutrients, and air may penetrate the lawn.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of lawn aeration, more specifically, an aerating-roller attachment for riding lawn mower.

### SUMMARY OF INVENTION

The aerating-roller attachment for riding lawn mower comprises a roller, a plurality of spikes, and a mounting bracket. The aerating-roller attachment for riding lawn mower may be coupled to a riding lawn mower via the mounting bracket and may aerate a lawn. The riding lawn mower may pull the roller behind the riding lawn mower and the roller may rotate as the riding lawn mower moves. The plurality of spikes may be pressed into the lawn and then withdrawn from the lawn as the roller turns. The weight of the riding lawn mower may force the plurality of spikes into the lawn leaving a plurality of aeration holes such that water, nutrients, and air may penetrate the lawn.

An object of the invention is to aerate a lawn.

Another object of the invention is to provide a roller covered with a plurality of spikes such that the spikes may pierce the lawn as the roller turns.

A further object of the invention is to provide a roller coupled to a riding lawn mower via a mounting bracket such that the weight of the riding lawn mower presses the spikes into the lawn.

Yet another object of the invention is to organize the plurality of spikes into cluster that may have a radial offset between adjacent clusters.

These together with additional objects, features and advantages of the aerating-roller attachment for riding lawn mower will be readily apparent to those of ordinary skill in the art upon reading the following detailed description of the presently preferred, but nonetheless illustrative, embodiments when taken in conjunction with the accompanying drawings.

In this respect, before explaining the current embodiments of the aerating-roller attachment for riding lawn mower in detail, it is to be understood that the aerating-roller attachment for riding lawn mower is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the aerating-roller attachment for riding lawn mower.

It is therefore important that the claims be regarded as including such equivalent construction insofar as they do not depart from the spirit and scope of the aerating-roller attachment for riding lawn mower. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is an isometric view of an embodiment of the disclosure.

FIG. 2 is a side view of an embodiment of the disclosure illustrating a 4 spike cluster with an offset angle between adjacent spike clusters.

FIG. 3 is a front view of an embodiment of the disclosure.

FIG. 4 is a side view of an alternative embodiment of the disclosure illustrating a 7 spike cluster.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

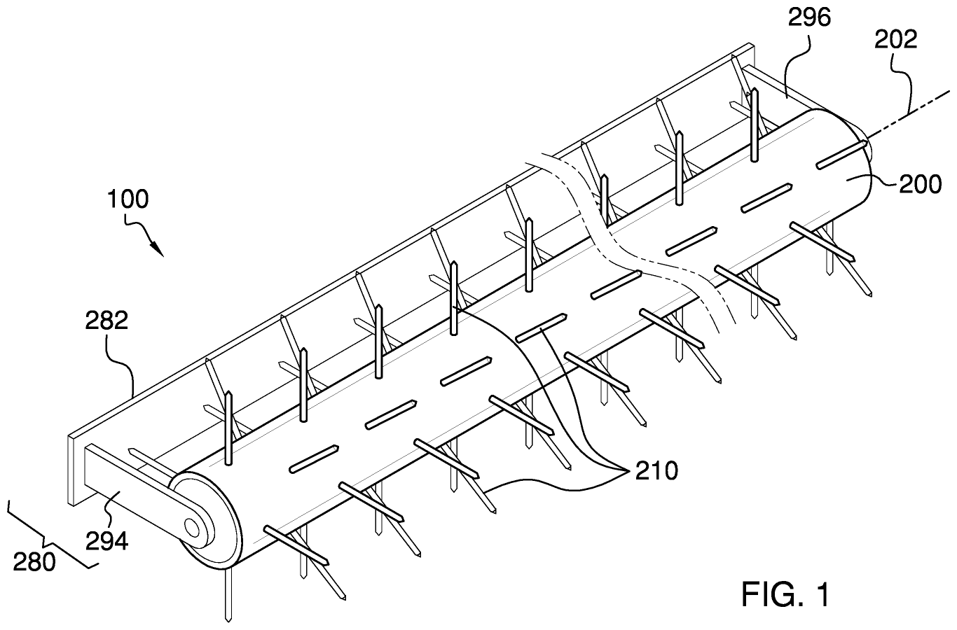

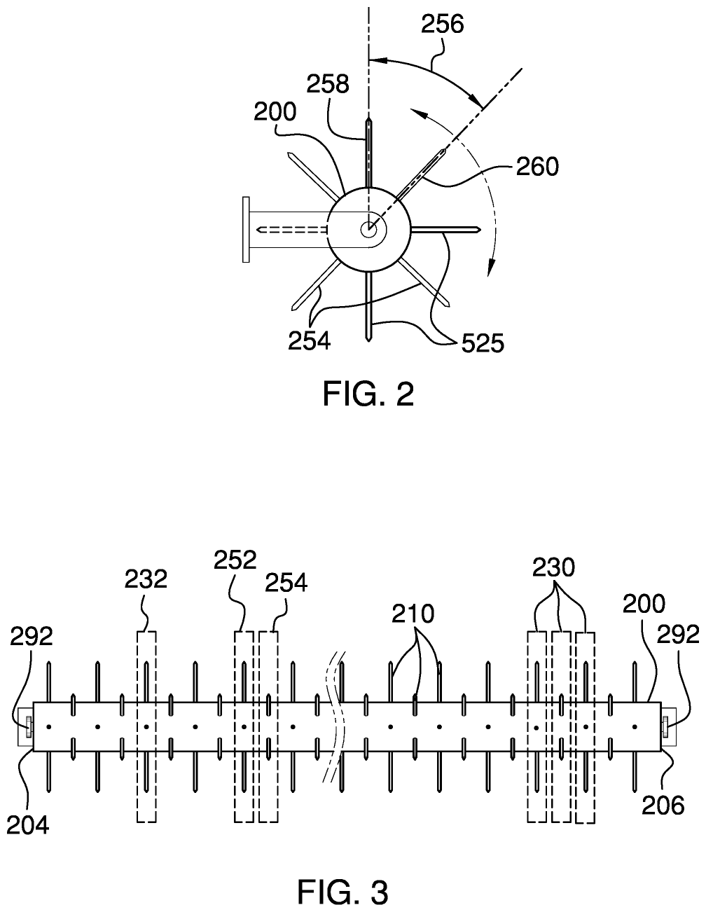

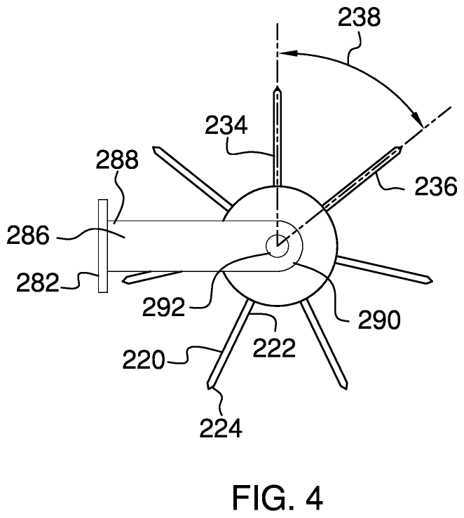

Detailed reference will now be made to a first potential embodiment of the disclosure, which is illustrated in FIGS. 1 through 4.

The aerating-roller attachment for riding lawn mower 100 (hereinafter invention) comprises a roller 200, a plurality of spikes 210, and a mounting bracket 280. The invention 100 may be coupled to a riding lawn mower via the mounting bracket 280 and may aerate a lawn. The riding lawn mower may pull the roller 200 behind the riding lawn mower and the roller 200 may rotate as the riding lawn mower moves. The plurality of spikes 210 may be pressed into the lawn and then withdrawn from the lawn as the roller 200 turns. The weight of the riding lawn mower may force the plurality of spikes 210 into the lawn leaving a plurality of aeration holes such that water, nutrients, and air may penetrate the lawn.

The roller 200 may be cylindrical and may rotate around a longitudinal axis 202. The longitudinal axis 202 may emerge from the roller 200 at the center of a left roller end 204 and at the center of a right roller end 206 and may be oriented parallel to the lawn. The plurality of spikes 210 may be dispersed on the roller 200 such that each of the individual spikes 220 comprising the plurality of spikes 210 may be oriented perpendicular to the longitudinal axis 202 of the roller 200.

The individual spike 220 may be defined by a distal spike end 224 and a proximal spike end 222. The distal spike end 224 may be coupled to the roller 200. The proximal spike end 222 may form a pointed tip such that the individual spike 220 may pierce the lawn.

The plurality of spikes 210 may be arranged into a plurality of spike clusters 230. An individual spike cluster 232 may be a subset of the plurality of spikes 210 that lie in the same plane that is perpendicular to the longitudinal axis 202. Said another way, all of the individual spikes 220 within the individual spike cluster 232 are located the same longitudinal distance from the left roller end 204 of the roller 200.

In some embodiments, the plurality of spikes 210 that are within the individual spike cluster 232 may be spaced radially such that the plurality of spikes 210 are distributed evenly around the longitudinal axis 202 at a separation angle 238. The separation angle 238 may be measured between a first spike 234 and a second spike 236 where the first spike 234 is adjacent to the second spike 236.

In some embodiments, the individual spike cluster 232 may comprise four of the individual spikes 220. In some embodiments, the individual spike cluster 232 may comprise seven of the individual spikes 220 such that the spacing between the plurality of aeration holes is reduced.

In some embodiments, the individual spike clusters 232 may be radially offset from each other by an offset angle 256. A first spike cluster 252 may be rotated by the offset angle 256 relative to a second spike cluster 254 such that the individual spikes 220 of the first spike cluster 252 do not longitudinally align with the individual spikes 220 of the second spike cluster 254. The offset angle 256 may be measured from a vertically oriented spike 258 of the first spike cluster 252 to a closest spike 260 of the second spike cluster 254.

The mounting bracket 280 may comprise an attachment plate 282 and a pair of mounting arms. The attachment plate 282 may be coupled to the riding lawn mower such that the roller 200 is positioned where the roller 200 may contact the lawn directly or indirectly via the plurality of spikes 210. The pair of mounting arms may project perpendicularly away from the attachment plate 282 to hold the roller 200 at a distance from the riding lawn mower such that the roller 200 and the plurality of spikes 210 may rotate without interference from the riding lawn mower. A left arm 294 may be coupled to the left end of the attachment plate 282 and a right arm 296 may be coupled to the right end of the attachment plate 282.

An individual mounting arm 286 selected from the left arm 294 and the right arm 296 may be defined by a proximal arm end 288 and a distal arm end 290. The proximal arm end 288 may couple to the attachment plate 282. The distal arm end 290 may comprise a pivot point 292. The roller 200 may couple to the pivot points 292 of the pair of mounting arms such that the longitudinal axis 202 of the roller 200 passes through the pivot points 292.

In some embodiments, the roller 200 may be made of plastic, rubber, composite resins, or combinations thereof.

In use, the mounting bracket 280 may be coupled top the riding lawn mower such that the plurality of spikes 210 press into the lawn. As the riding lawn mower moves forward, the roller 200 may rotate and each rotation of the roller 200 may press the plurality of spikes 210 into the lawn. The riding lawn mower may be driven over the lawn leaving the plurality of aeration holes behind the riding lawn mower.

### Definitions

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” may refer to top and “lower” may refer to the bottom. As a non-limiting example, the upper end of a vertical shaft is the top end of the vertical shaft.

As used herein, “align” may refer to the placement of two or more components into positions and orientations which either arranges the components along a straight line or within the same plane or which will allow the next step of assembly to proceed. As a non-limiting example, the next step of assembly may be to insert one component into another component, requiring alignment of the components.

As used herein, the words “couple”, “couples”, “coupled” or “coupling”, may refer to connecting, either directly or indirectly, and does not necessarily imply a mechanical connection.

As used in this disclosure, the terms “distal” and “proximal” may be used to describe relative positions. Distal refers to the object, or the end of an object, that is situated away from the point of origin, point of reference, or point of attachment. Proximal refers to an object, or end of an object, that is situated towards the point of origin, point of reference, or point of attachment. Distal implies ‘farther away from’ and proximal implies ‘closer to’. In some instances, the point of attachment may be the where an operator or user of the object makes contact with the object. In some instances, the point of origin or point of reference may be a center point, a central axis, or a centerline of an object and the direction of comparison may be in a radial or lateral direction.

As used herein, the word “longitudinal” or “longitudinally” may refer to a lengthwise or longest direction.

As used herein, the word “pivot” may include any mechanical arrangement that allows for rotational motion. Non-limiting examples of pivots may include hinges, holes, posts, dowels, pins, points, rods, shafts, balls, and sockets, either individually or in combination.

As used in this disclosure, “vertical” may refer to a direction that is parallel to the local force of gravity. Unless specifically noted in this disclosure, the vertical direction is always perpendicular to horizontal.

With respect to the above description, it is to be realized that the optimum dimensional relationship for the various components of the invention described above and in FIGS. 1 through 4, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. An aerating-roller attachment for riding lawn mower comprising:
a roller, a plurality of spikes, and a mounting bracket;
wherein the aerating-roller attachment for riding lawn mower is coupled to a riding lawn mower via the mounting bracket and aerates a lawn;
wherein the riding lawn mower pulls the roller behind the riding lawn mower and the roller rotates as the riding lawn mower moves;
wherein the plurality of spikes are pressed into the lawn and then withdrawn from the lawn as the roller turns;
wherein the weight of the riding lawn mower forces the plurality of spikes into the lawn leaving a plurality of aeration holes such that water, nutrients, and air penetrate the lawn.

2. The aerating-roller attachment for riding lawn mower according to claim 1
wherein the roller is cylindrical and rotates around a longitudinal axis.

3. The aerating-roller attachment for riding lawn mower according to claim 2
wherein the longitudinal axis emerges from the roller at the center of a left roller end and at the center of a right roller end and is oriented parallel to the lawn.

4. The aerating-roller attachment for riding lawn mower according to claim 3
wherein the plurality of spikes are dispersed on the roller such that each of the individual spikes comprising the plurality of spikes are oriented perpendicular to the longitudinal axis of the roller.

5. The aerating-roller attachment for riding lawn mower according to claim 4
wherein the individual spike is defined by a distal spike end and a proximal spike end;
wherein the distal spike end is coupled to the roller.

6. The aerating-roller attachment for riding lawn mower according to claim 5
wherein the proximal spike end forms a pointed tip such that the individual spike pierces the lawn.

7. The aerating-roller attachment for riding lawn mower according to claim 6
wherein the plurality of spikes are arranged into a plurality of spike clusters.

8. The aerating-roller attachment for riding lawn mower according to claim 7
wherein an individual spike cluster is a subset of the plurality of spikes that lie in the same plane that is perpendicular to the longitudinal axis.

9. The aerating-roller attachment for riding lawn mower according to claim 8
wherein the plurality of spikes that are within the individual spike cluster are spaced radially such that the plurality of spikes are distributed evenly around the longitudinal axis at a separation angle.

10. The aerating-roller attachment for riding lawn mower according to claim 9
wherein the individual spike cluster comprises four of the individual spikes.

11. The aerating-roller attachment for riding lawn mower according to claim 9
wherein the individual spike cluster comprises seven of the individual spikes.

12. The aerating-roller attachment for riding lawn mower according to claim 9
wherein the individual spike clusters are radially offset from each other by an offset angle.

13. The aerating-roller attachment for riding lawn mower according to claim 12
wherein a first spike cluster is rotated by the offset angle relative to a second spike cluster such that the individual spikes of the first spike cluster do not longitudinally align with the individual spikes of the second spike cluster;
wherein the offset angle is measured from a vertically oriented spike of the first spike cluster to a closest spike of the second spike cluster.

14. The aerating-roller attachment for riding lawn mower according to claim 9
wherein the mounting bracket comprises an attachment plate and a pair of mounting arms;
wherein the attachment plate is coupled to the riding lawn mower such that the roller is positioned where the roller contacts the lawn directly or indirectly via the plurality of spikes.

15. The aerating-roller attachment for riding lawn mower according to claim 14
wherein the pair of mounting arms project perpendicularly away from the attachment plate to hold the roller at a distance from the riding lawn mower such that the roller and the plurality of spikes rotate without interference from the riding lawn mower;
wherein a left arm is coupled to the left end of the attachment plate and a right arm is coupled to the right end of the attachment plate.

16. The aerating-roller attachment for riding lawn mower according to claim 15
wherein an individual mounting arm selected from the left arm and the right arm is defined by a proximal arm end and a distal arm end;
wherein the proximal arm end couples to the attachment plate;
wherein the distal arm end comprises a pivot point.

17. The aerating-roller attachment for riding lawn mower according to claim 16
wherein the roller couples to the pivot points of the pair of mounting arms such that the longitudinal axis of the roller passes through the pivot points.

18. The aerating-roller attachment for riding lawn mower according to claim 17
wherein the roller is made of plastic, rubber, composite resins, or combinations thereof.
